(19) United States
(12) Patent Application Publication
(10) Pub. No.: US 2013/0262017 A1
(43) Pub. Date: Oct. 3, 2013

(54) METHOD AND APPARATUS FOR REUSING PARTS OF EXISTING TESTS

(71) Applicants: Itai Segall, Tel-Aviv (IL); Rachel Tzoref-Brill, Haifa (IL); Aviad Zlotnick, Mitzpeh Netofah (IL)

(72) Inventors: Itai Segall, Tel-Aviv (IL); Rachel Tzoref-Brill, Haifa (IL); Aviad Zlotnick, Mitzpeh Netofah (IL)

(73) Assignee: International Business Machines Corporation, Armonk, NY (US)

(21) Appl. No.: 13/437,945

(22) Filed: Apr. 3, 2012

(51) Int. Cl. G06F 19/00

(52) U.S. Cl. 702/108

(57) ABSTRACT

An apparatus, computer-implemented method performed by a computerized device and a computer program product, the method comprising: receiving an attribute collection related to a domain, the attribute collection comprising two or more attributes; receiving one or more restrictions, each restriction indicating one or more attributes, wherein a value for the attribute is to be selected from one existing test; receiving an existing test; and generating one or more new tests by setting values for the two or more attributes, wherein values for the one or more attributes of the one or more restrictions are selected from the existing test, and one or more values for one or more other attributes are not selected from the existing test.

### TECHNICAL FIELD

The present disclosure relates to testing in general, and to a hybrid approach combining test selection and generation, in particular.

### BACKGROUND

Computerized devices control almost every aspect of our life—from writing documents to controlling traffic lights. However, computerized systems are bug-prone, and thus require a testing phase in which the bugs should be discovered. The testing phase is considered one of the most difficult tasks in designing a computerized device. The cost of not discovering a bug may be enormous, as the consequences of the bug may be disastrous. For example, a bug may cause the injury of a person relying on the designated behavior of the computerized system. Additionally, a bug in hardware or firmware of a marketed product may be expensive to fix, as patching it requires call-back of the computerized device. Hence, many developers of computerized systems invest a substantial portion of the development cycle to discover erroneous behaviors of the computerized device.

An important part of testing relates to test planning and design, i.e., providing a set of tests that adequately cover the system, such that if all tests pass the system is assumed to be operative. However, it is generally required to increase testing efficiency and reduce the number or total cost of the tests as much as possible.

A common methodology for test planning and design is Combinatorial Test Design (CTD). CTD may be used when describing a problem as a set of attributes or properties, values corresponding to the attributes, and restrictions on combinations of values that may not appear together in a test. Each test comprises a value for each attribute, such that the combination represents a particular situation. Thus, a test may be represented as a tuple in which every attribute is assigned a value.

Consider for example a healthcare system which needs to be tested. Each test may comprise details of a patient such as age group, living area, medical details, number of times the patient received medical treatment in the last month, etc.; details associated with a care giver, such as discipline, years of experience, practicing area, or the like; and details of the provided medical treatment such as kind of treatment, diagnosis, wherein the treatment was provided, etc. The healthcare provider may set a coverage goal, for example, of pairwise testing, i.e., each possible value for any patient detail has to be tested with each possible value for any caregiver detail, and similarly for any other pair of details. Thus, a test may relate to a young patient with a broken leg. However, other details associated with the same test may indicate that the caregiver is a pediatric doctor, practicing at a private clinic, or any other combination. Thus, a single test may cover a multiplicity of pairs. In other systems, different requirements may be posed, for example three-way testing may be required.

It will be appreciated that the term test may relate to the values assigned to the attributes, to data associated with tests, to production data, to testing manufacturing processes and results, or the like. A test may or may not indicate how the test is to be performed.

When constructing a test plan for achieving a required coverage level for a system, two main disciplines exist: test generation and test selection. Test generation may relate to a set of tests, i.e., sets of attribute values, generated from scratch. However, test planning algorithms such as CTD may generate tests which may be hard or expensive to implement, due to the cost, the required effort, or the like. For example, generating data that relates to a patient that received five treatments in the past year by five different caregivers in five different locations may take significant effort.

Test selection is a complementary approach. In test selection, a set of tests is given, for example provided by the system designer such as the designer of the healthcare system. A subset of the tests may then be selected, which maintains the same coverage. For example, given tests A, B and C, wherein test A and test B have the same attributes excluding patient age group and living area and test C has the same patient age group and living area as test B, test B can be eliminated.

The advantage of test selection over test generation is that no new tests need to be generated. The disadvantage is, however, that typically existing tests achieve relatively low coverage. Test selection does not improve coverage of the test plan, but merely reduces its size, thus leaving low coverage.

### BRIEF SUMMARY

One aspect of the disclosure relates to a computer-implemented method performed by a computerized device, comprising: receiving an attribute collection related to a domain, the attribute collection comprising two or more attributes; receiving one or more restrictions, each restriction indicating one or more attributes, wherein a value for the attribute is to be selected from one existing test; receiving an existing test; and generating one or more new test by setting a values for the attributes, wherein the values for the attributes are selected from the existing test, and one or more values for one or more other attribute are not selected from the existing test.

Another aspect of the disclosure relates to an apparatus having a processing unit and a storage device, the apparatus comprising: a data receiving component for receiving an attribute collection related to a domain, the attribute collection comprising two or more attributes, one or more restrictions, each restriction indicating one or more attributes, wherein a value for the attributes are to be selected from one existing test, and an existing test; and a test generation component for generating one or more new tests in compliance with the restriction, the test generation component comprising: an attribute selection component for selecting values for the attributes in the new test from the existing test; and an attribute assignment component for assigning one or more values for one or more other attributes in the new test, wherein the values are not selected from the existing test.

Yet another aspect of the disclosure relates to a computer program product comprising: a non-transitory computer readable medium; a first program instruction for receiving an attribute collection related to a domain, the attribute collection comprising two or more attributes; a second program instruction for receiving one or more restrictions, each restriction indicating one or more attributes, wherein a value for the attributes are to be selected from one existing test; a third program instruction for receiving an existing test; and a fourth program instruction for generating one or more new tests by setting a values for the attributes, wherein the values for the attributes are selected from the existing test, and one or more values for one or more other attributes are not selected from the existing test, wherein said first, second third and fourth program instructions are stored on said non-transitory computer readable medium.

### BRIEF DESCRIPTION OF THE SEVERAL VIEWS OF THE DRAWINGS

The present disclosed subject matter will be understood and appreciated more fully from the following detailed description taken in conjunction with the drawings in which corresponding or like numerals or characters indicate corresponding or like components. Unless indicated otherwise, the drawings provide exemplary embodiments or aspects of the disclosure and do not limit the scope of the disclosure. In the drawings:

FIG. 1 shows an example of a hybrid approach for combining test selection and test generation, in accordance with some exemplary embodiments of the disclosed subject matter;

FIG. 2 shows a flowchart diagram of steps in a method for combining test selection and test generation, in accordance with some exemplary embodiments of the disclosed subject matter; and

FIG. 3 shows a block diagram of components of an apparatus for combining test selection and test generation, in accordance with some exemplary embodiments of the disclosed subject matter.

### DETAILED DESCRIPTION

The disclosed subject matter is described below with reference to flowchart illustrations and/or block diagrams of methods, apparatus (systems) and computer program products according to embodiments of the subject matter. It will be understood that blocks of the flowchart illustrations and/or block diagrams, and combinations of blocks in the flowchart illustrations and/or block diagrams, can be implemented by computer program instructions. These computer program instructions may be provided to one or more processors of a general purpose computer, special purpose computer, a tested processor, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a non-transient computer-readable medium that can direct a computer or other programmable data processing apparatus to function in a particular manner, such that the instructions stored in the non-transient computer-readable medium produce an article of manufacture including instruction means which implement the function/act specified in the flowchart and/or block diagram block or blocks.

The computer program instructions may also be loaded onto a device. A computer or other programmable data processing apparatus to cause a series of operational steps to be performed on the computer or other programmable apparatus to produce a computer implemented process such that the instructions which execute on the computer or other programmable apparatus provide processes for implementing the functions/acts specified in the flowchart and/or block diagram block or blocks.

One technical problem dealt with by the disclosed subject matter is the creation of one or more tests for testing a system. It is noted that a test in this context comprises a collection of values for the attributes of the system. For example, in a healthcare system which needs to be tested, each test may comprise details of a patient such as age group, living area, medical details, number of times the patient received medical treatment in the last month, etc.; details associated with a care giver, such as discipline, years of experience, practicing area, or the like; and details of the provided medical treatment such as kind of treatment, diagnosis, wherein the treatment was provided, etc. It will be appreciated in this context that a test does not necessarily indicate how testing is to be done, but rather indicates values for the attributes. Tests should be generated so as to reach a coverage goal which may be defined by a user, so that when all the tests pass the system is assumed to be functional. A coverage goal may be, for example pair-wise testing of all attributes, i.e., each possible value for any patient detail has to be tested with each possible value for any caregiver detail, and similarly for any other pair of details. A coverage goal may include combinations or combination sets, may indicate for example, pair-wise testing of particular attributes, three-way testing of others, free setting of yet other attributes, or the like.

Currently available techniques include test generation. However, a major inhibitor for test generation is that data or setup for the generated tests may be expensive to produce. Another available technique is test selection, in which a subset of tests is selected from a corpus of tests. However, test selection may suffer from poor coverage of the system, which is not improved by selection of a subset of the tests.

It may thus be beneficial to combine the two approaches. A known solution comprises combining test generation and test selection, by first enhancing a given test plan to complete the coverage goal by adding tests, and then applying test selection on the extended test plan. However, this solution may still require the full generation of newly create tests, which may disqualify the solution since the complete test generation may end up being too expensive.

Thus, it is required to produce one or more tests which provide the desired coverage as defined by the designer or another person on one hand, but can be generated from a practical point of view, on the other hand.

One technical solution comprises combining selection and optionally generation within each test. The solution comprises receiving from a user a corpus of existing tests, and one or more indications to attribute combinations of for which values need to be selected from existing tests, while other attributes can be selected from other tests or in any other manner.

For example, assume a system with 6 Boolean attributes: A, B, C, D, E and F. A user may specify that the combination of A and B must be selected from one of the given tests. Thus, for example, the combination of particular values for A and B, such as A=true and B=true is allowed to appear in the constructed test only if it appears in a test already existing in the corpus, and similarly for other combinations of values for A and B. A similar restriction may be set by the user for attributes C and D, such that a combination of values for C and D may appear in the result only if it appears in an existing test. However, there is no requirement that a combination of values for A, B, C and D must appear as is in an existing test. Rather a test may be suggested for which the values for A and B are selected from one existing test, and the values for C and D are selected from another existing test. Other values, such as E and F may be selected from any one or more tests or made up.

It will be appreciated that some requirements may also relate to single attributes. For example, an age attribute may be limited to the range of 0-120, and if indicated as “selected” then the value assigned for this attribute must be selected from existing tests.

Some general restrictions may apply which may relate to possible or impossible combinations, regardless of whether such combinations appear in existing tests or not. It will be further appreciated that some restrictions may relate to combinations which are ruled out and should not be set, for example an elderly patient and a pediatrician, or the like.

Further tests may be generated in accordance with the requirements set by the user, until the desired coverage goal is achieved. It will be appreciated that the coverage goal may be achieved only as much as possible with the given tests and restrictions. For example, if the coverage goal indicates pair-wise testing, and a particular combination is marked to be selected but a set of values for the combination attributes does not appear in the given test set, this combination cannot be tested. Thus, the coverage goal is to be determined in accordance with the restrictions and the values available within the given test set.

Thus, combinations of values that are hard to generate should be marked by the user for selection, such that any combination appearing in the test plan already exists in the given set of tests and can be reused. On the other hand, for the other attributes the best possible values can be selected or assigned freely, i.e., without requiring them to appear in a test, which enables to achieve coverage with minimum tests.

One technical effect of utilizing the disclosed subject matter is the achievement of the test coverage goal, while avoiding generation of expensive tests, i.e., tests comprising combinations that are known to be expensive to generate. This hybrid approach utilizes the advantages of test selection, being low cost of tests (or using tests for which the price was already paid), with the advantage of test generation, being efficient coverage of the system.

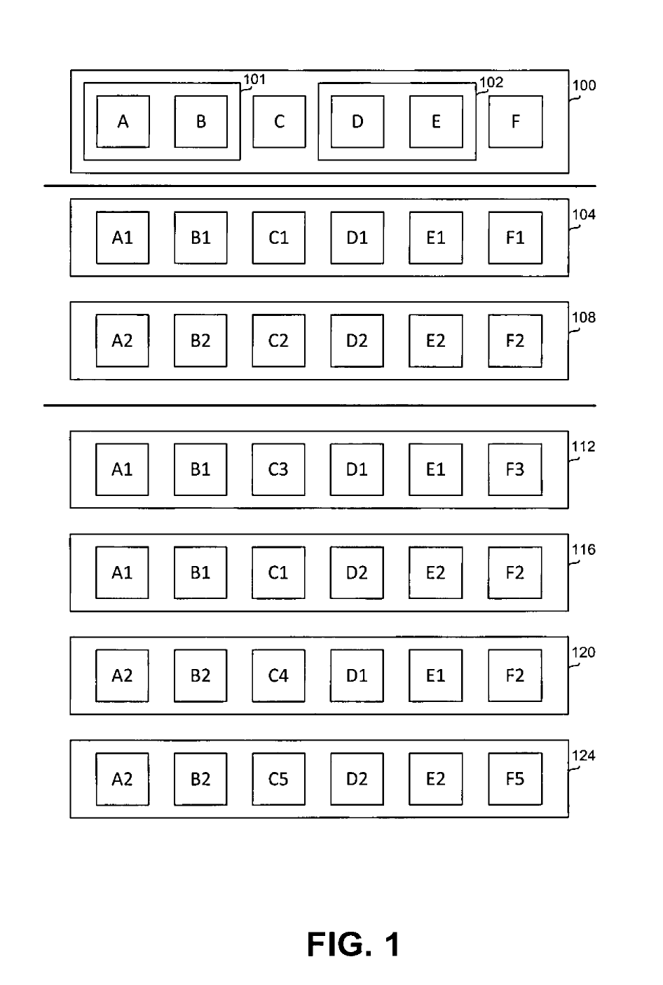

Referring now to FIG. 1, showing a schematic illustration exemplifying the hybrid approach for combining test selection and test generation.

Attribute collection 100 contains 6 attributes, A, B, C, D, E and F. The attributes are associated with a testable component such as a unit undergoing unit test, a full system, a design, or the like.

The user indicated combination 101 of A and B attributes and combination 102 of D and E attributes as combinations that should be selected from existing tests, rather than generated from scratch.

Collections 104 and 108 indicate the attribute values as set for two available tests, from which selections can be made. Collection 104 tests the system with attribute values A1 through F1, and collection 108 tests the system with attribute values A2 through F2.

Collections 112, 116, 120, and 124 describe some tests that can be generated by the disclosed method and apparatus.

In collection 112 combination 101 and combination 102 are both selected from test 104, and new values created are for the two remaining attributes C and F. Thus, collection 112 contains the combinations of A1-B1 and D1-E1 as selected from test 104, and newly generated values C3 and F3.

In collection 116, combination 101 was selected from test 104 and combination 102 was selected from test 108. Collection 116 also used two values appearing in tests 104 and 108 for the other attributes. Thus, collection 116 contains the combination of A1 and B1 selected from test 104, the combination of D2 and E2 selected from test 108, Cl value from test 104 and F2 from test 108.

In collection 120, combination 101 was selected from test 108 and combination 102 was selected from test 104. Collection 120 also used value F2 for attribute F from test 108, and assigned a new value C4 for attribute C. The value assigned to C may be generated freely, or selected from a collection of possible values, if such collection has been indicated, for example a range of 0-120 may be indicated for an age attribute. Thus, collection 120 contains the combination of A2 and B2 selected from test 108, the combination of D1 and E1 selected from test 104, newly created value C4, and F2 as selected from test 108.

In collection 124, combinations 101 and 102 were selected from test 108, and new values were generated for attributes C and F, being C5 and F5. Thus, collection 124 contains the combinations of A2-B2 and D2-E2 from test 108 and newly created values C5 and F5.

It will be appreciated that other combinations may be created in which the A and B combination is selected from test 104 or test 108, the D and E combination is selected from test 104 or test 108, and each of C and F can be selected from test 104, test 108, any other available test or can be newly created.

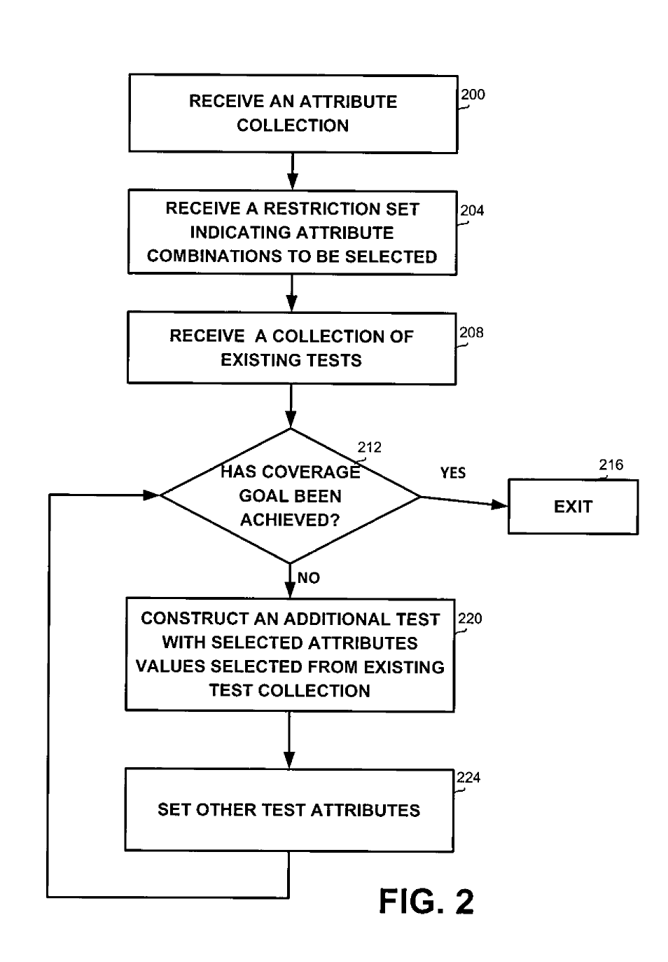

Referring now to FIG. 2, showing a flowchart diagram of steps in a method for combining test selection and test generation.

On step 200, an attribute collection associated with a domain or a system may be received. For example, in the case of a healthcare system, the set of attributes may include a collection of patient demographic and medical details, caregiver details, the details of a treatment provided by the caregiver to the patient, the details of the institute where the treatment was provided, or the like.

On step 204, a restriction set may be received, indicating a restriction collection, comprising one or more combinations of attributes that have to be selected from given tests. It will be appreciated that each combination may comprise two or more attributes. However, each combination may be selected from a different test, or two or more combinations may be selected from a particular test. For example, if A and B are indicated as a combination to be selected, and similarly for C and D, then A and B must be selected from the same test, and C and D must be selected from the same test, but A, B, C and D do not have to be selected all from the same test. Zero, one or more restrictions may relate to a single attribute; zero, one or more others may relate to combinations of a two attributes; zero, one or more yet others may relate to combinations of a three attributes, and so on. It will be appreciated that overlaps may exist between restrictions. For example one restriction may relate to the combination of A and B, and another restriction may relate to the combination of A and C. In such situation, all values may or may not be selected from a single test. For example, if a first test has (A=1,B=1,C=1) and a second test has (A=1,B=2,C=2), then the new test may have (A=1,B=1,C=2) which complies with the two restrictions but A, B and C are not selected from the same test. It will be appreciated that since a restriction relates to at least two attributes, and the restriction does not refer to all the attributes (otherwise the only solution would be to take an existing test), the attribute set comprises at least three attributes.

On step 208 a collection of existing tests may be received, wherein each test may indicate a value for each attribute. The combinations indicated on step 204 as those that have to be selected, may be selected from any of the received tests. It will be appreciated that the existing test collection may or may not be part of the test collection eventually provided by the method. Thus, in some embodiments, the created test collection may begin with an empty set, and tests may be added as the method proceeds. In other embodiments, the existing test set may be utilized as an initial set, and newly generated tests may be added to it. In yet other embodiments, initial processing may be performed upon the initial set in order to reduce the number of tests while substantially maintaining the same or similar coverage, followed by creating new tests and adding them to the reduced initial set.

On step 212, it is determined whether a coverage goal which may be stated by a user or received from an external source has been achieved. The coverage goal may be, for example, pair-wise coverage i.e., all combinations of two attributes have to be tested, for example young patient and orthopedist, old patient and at least one visit to the clinic in the last months, or the like. It will be appreciated that some combinations may be forbidden, excluded or ruled out, for example a young patient and a geriatrician, or the like, such that zero, one or more combinations are to be selected and zero, one or more other combinations are forbidden. It will also be appreciated that the coverage goal should be determined in accordance with the available tests, since a “selected” combination for which a set of values is not available within the given test set cannot be tested.

If the coverage goal has been achieved, then no more tests are required and the method may exit on step 216.

If the goal has not been achieved, a new test is generated on step 220 in compliance with the restrictions. The test is generated by setting values for the attributes, such that all attribute combinations indicated on step 204 are selected from any one or more of the tests received on step 208, resulting in that at least one attribute of the test is being selected from one of the given tests. If multiple restrictions were received, the values for attributes of that restriction are taken from the same test, while values for attributes of another restriction may be taken from another test.

On step 224 non-selected attributes may be set, for example by being newly generated. In some embodiments, each such new test as generated by steps 220 and 224 is generated so that it extends the existing coverage.

It will be appreciated that the iterative flow represented in FIG. 2 is exemplary only, and that alternative embodiments may be designed. For example, some algorithms may expand a particular restriction for a multiplicity of tests and then move to the next restriction. Other algorithms may start with a larger set of tests and take out redundant ones, or the like.

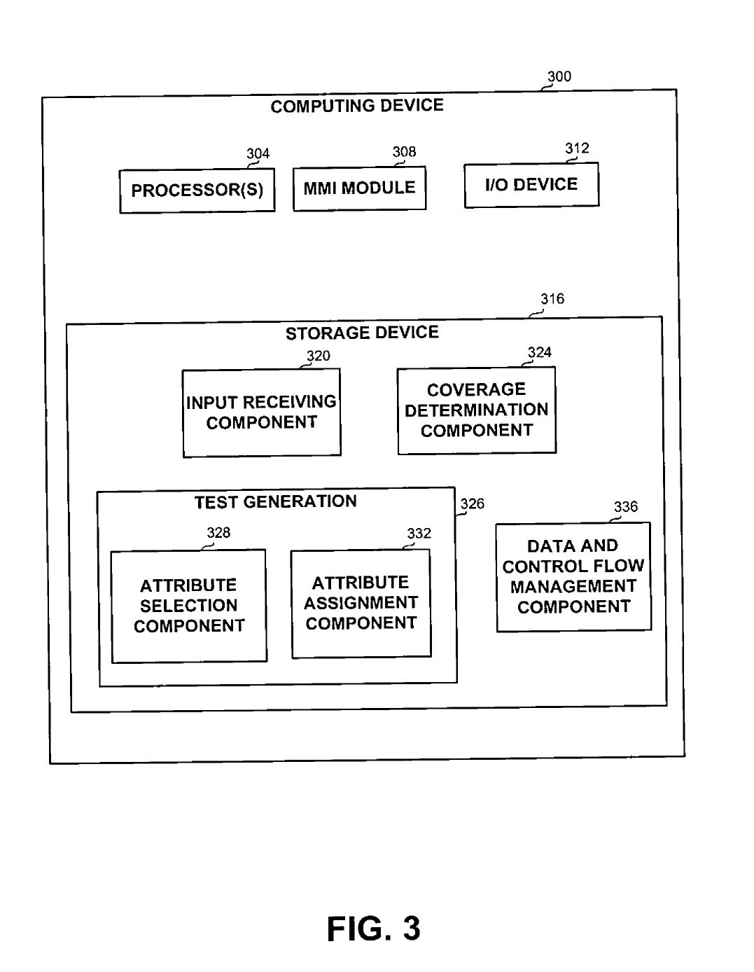

Referring now to FIG. 3, showing a block diagram of components of an apparatus for combining test selection and test generation, in accordance with some exemplary embodiments of the disclosed subject matter.

The apparatus may comprise a computing platform 300. Computing platform 300 may comprise a processor 304. Processor 304 may be a Central Processing Unit (CPU), a microprocessor, an electronic circuit, an Integrated Circuit (IC) or the like. Alternatively, computing platform 300 can be implemented as firmware writen for or ported to a specific processor such as digital signal processor (DSP) or microcontrollers, or can be implemented as hardware or configurable hardware such as field programmable gate array (FPGA) or application specific integrated circuit (ASIC). Processor 304 may be utilized to perform computations required by computing platform 300 or any of it subcomponents.

In some exemplary embodiments of the disclosed subject matter, comptuing platform 300 may comprise MMI module 308. MMI module 308 may be utilized to provide communication between the apparatus and a user for providing input such as describing the restrictions, receiving output such as suggested tests, or the like.

In some embodiments, computing platform 300 may comprise an input-output (I/O) device 312 such as a terminal, a display, a keyboard, an input device or the like, used to interact with the system, to invoke the system and to receive results. It will however be appreciated that the system can operate without human operation.

In some exemplary embodiments, comptuing platform 300 may comprise one or more storage devices such as storage device 316. Storage device 312 may be persistent or volatile. For example, storage device 316 can be a Flash disk, a Random Access Memory (RAM), a memory chip, an optical storage device such as a CD, a DVD, or a laser disk; a magnetic storage device such as a tape, a hard disk, storage area network (SAN), a network attached storage (NAS), or others; a semiconductor storage device such as Flash device, memory stick, or the like. In some exemplary embodiments, storage device 316 may retain program code operative to cause processor 304 to perform acts associated with any of the steps shown in FIG. 2 above, for example generating tests, checking coverage, or the like.

The components detailed below may be implemented as one or more sets of interrelated computer instructions, executed for example by processor 304 or by another processor. The components may be arranged as one or more executable files, dynamic libraries, static libraries, methods, functions, services, or the like, programmed in any programming language and under any computing environment.

Storage device 316 may comprise an input receiving component 320 for receiving input, including for example the attribute set of the system to be tested, the restrictions, or the existing tests. The input may be received via a network, computer communication using any protocol, an external storage device, retrieved from a database, or the like.

Storage device 312 may further comprise coverage determination component 324 for determining whether the generated collection of tests provides adequate coverage of the system, wherein the coverage goal may be provided by a user.

Storage device 312 may also comprise test generation component 326 for generating tests in compliance with the restrictions.

Test generation component 326 may comprise attribute selection component 328 for selecting attributes for restricted combinations from existing tests, and attribute assignment component 332 for generating or otherwise receiving values for those attributes which do not constitute part of a restricted combination,

Storage device 312 may also comprise data and control flow management component 336 for managing the flow of information and control between other components, for example storing the tests and restrictions received by input receiving component 320, generating tests using attribute selection component 328 and attribute assignment component 332, determining coverage by coverage determination component 324, or the like.

The disclosed methods and apparatus enable the generation of tests in accordance with user-provided restrictions indicating combinations of attributes the values of which have to be selected from existing tests, while the values of other attributes may be selected or generated freely.

It will be appreciated that multiple enhancements and modifications may exist to the method and apparatus.

One such enhancement may relate to cases in which combinations may be set for being selectable in conditional manner using any formal logic, for example if A=1 then the combination of B and C attributes must be selected, i.e., assigned values that should be taken from the same existing test, otherwise (if A is not equal to 1) the values of B and C may be freely selected or generated. In another example, a combination of A and B in which A is equal to B must be selected, i.e., in any test in which A and B are equal, their values have to be selected from an existing test, while other combinations in which A is different from B may be selected or set in any required manner.

Another enhancement may relate to mixed restrictions. For example A may either take a value between 1-10 which already exists in a given test, or an arbitrary value between 11-20. Similar restrictions may be applicable to combinations, for example the combinations A=1 and B=1, A=1 and B=2, and A=2 and B=2 may be used only if they are already uses in existing tests, but other combinations for A and B may be assigned freely”.

In yet another enhancement, instead of a combination being marked as “select” or otherwise it may be generated or assigned freely, combinations may be associated with a generation weight or cost. Thus, a “select” indication may be interpreted as an infinite generation cost, while a “generate” indication is interpreted as a zero generation cost, and any other value may be assigned as well. Thus, when trying to minimize the cost, combinations indicated as “select” will, if feasible, be selected, while other attributes will be selected or generated in accordance with the associated cost. The goal of such generation may be to minimize or reduce the cost of each test or of the whole corpus of generated tests, while achieving the required coverage goal.

The latest modification may also be extended to a situation in which data generation is always possible, but is associated with a cost. In this scenario, a user may prefer to reuse as much existing data as possible, but without reducing coverage or sacrificing succinctness. A possible approach to this modification would be to:

1. Generate a test plan comprising a multiplicity of tests, while ignoring existing tests. Alternatively, a test plan may be obtained from any source.

2. Identify attribute values or combinations thereof in one or more tests of the test plan, which may be modified without reducing coverage, i.e., combinations that are not required to be covered, or combinations that are covered by other tests, so changing the values of these attributes will not decrease the number of value combinations covered for these attributes.

3. Replace such combinations with values from existing tests, thus not requiring further value generation resources.

This approach does not change the size of the test plan, nor its coverage, but may reduce the amount of data that requires generation by using existing data. This approach may or may not use user intervention in identifying combinations that are hard to generate vs. ones that are easier. It will be appreciated that this enhancement can be applied to a partial set of the attributes. It will also be appreciated that this approach can be implemented without a restriction. The algorithm can try and change combinations that do not affect coverage, even if the user didn't specify these combinations.

It will be appreciated that the disclosed subject matter can be used in any stage of the system development, including design, unit test, system test, debugging or others. It will also be appreciated that the disclosed subject matter can be applied to any discipline for which computerized systems are developed, and which can be modeled as a collection of attributes and values, for example healthcare, banking, insurance, finance, shipments, manufacturing, education, tourism, commerce, or the like.

The flowchart and block diagrams in the figures illustrate the architecture, functionality, and operation of possible implementations of systems, methods and computer program products according to various embodiments of the present disclosure. In this regard, each block in the flowchart and some of the blocks in the block diagrams may represent a module, segment, or portion of program code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

As will be appreciated by one skilled in the art, the disclosed subject matter may be embodied as a system, method or computer program product. Accordingly, the disclosed subject matter may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present disclosure may take the form of a computer program product embodied in any tangible medium of expression having computer-usable program code embodied in the medium.

Any combination of one or more computer usable or computer readable medium(s) may be utilized. The computer-usable or computer-readable medium may be, for example but not limited to, any non-transitory computer-readable medium, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CDROM), an optical storage device, a transmission media such as those supporting the Internet or an intranet, or a magnetic storage device. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to wireless, wireline, optical fiber cable, RF, and the like.

Computer program code for carrying out operations of the present disclosure may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The embodiment was chosen and described in order to best explain the principles of the disclosure and the practical application, and to enable others of ordinary skill in the art to understand the disclosure for various embodiments with various modifications as are suited to the particular use contemplated.

What is claimed is:

1. A computer-implemented method performed by a computerized device, comprising:
receiving an attribute collection related to a domain, the attribute collection comprising at least two attributes;
receiving at least one restriction, the at least one restriction indicating at least one attribute, wherein a value for the at least one attribute is to be selected from one existing test;
receiving an existing test; and
generating at least one new test by setting values for the at least two attributes, wherein values for the at least one attribute of the at least one restriction are selected from the existing test, and at least one value for at least one other attribute are not selected from the existing test.

2. The computer-implemented method of claim 1, wherein the at least one restriction relates to at least two attributes.

3. The computer-implemented method of claim 2, wherein the at least one restriction further comprises a restriction related to excluded combinations of values for the at least two attributes.

4. The computer-implemented method of claim 1, wherein said generating is repeated until a coverage goal is reached.

5. The computer-implemented method of claim 1, wherein the at least one value for the at least one other attribute is selected from a second existing test.

6. The computer-implemented method of claim 1, wherein values for the at least one attribute of the at least one restriction are selected from a first existing test, and values for the at least one attribute of at least one second restriction are selected from a second existing test.

7. The computer-implemented method of claim 1, wherein the at least one value for the at least one other attribute is generated.

8. The computer-implemented method of claim 1, wherein the at least one restriction is conditional and depends on a value of at least one attribute.

9. The computer-implemented method of claim 1, wherein the at least one restriction is conditional and depends on relations between values of at least two attributes.

10. The computer-implemented method of claim 1, wherein the at least one restriction indicates at least one possible value for at least one attribute.

11. The computer-implemented method of claim 1, wherein the at least one restriction indicates at least one possible value to be selected for the at least one attribute from an existing test, and at least one possible value to be assigned freely to the at least one attribute, or in accordance with a restriction not related to the existing test.

12. The computer-implemented method of claim 1, wherein at least one combination is associated with a cost, such that a combination to be selected is associated with a high cost and a combination to be generated is associated with a low cost, and it is required to achieve a coverage goal while reducing costs.

13. A computer-implemented method performed by a computerized device, comprising:
receiving an attribute collection related to a domain, the attribute collection comprising at least two attributes;
receiving one or more existing tests;
obtaining a test plan;
identifying combinations of at least one value in at least one test in the test plan that can be changed without reducing coverage; and
replacing the combinations of the at least one value with at least one value from the one or more existing tests.

14. An apparatus having a processing unit and a storage device, the apparatus comprising:
a data receiving component for receiving an attribute collection related to a domain, the attribute collection comprising at least two attributes, at least one restriction, the at least one restriction indicating at least one attribute, wherein a value for the at least one attribute is to be selected from one existing test, and an existing test; and
a test generation component for generating at least one new test in compliance with the restriction, the test generation component comprising:
an attribute selection component for selecting values for the at least one attribute in the new test from the existing test; and
an attribute assignment component for assigning at least one value for at least one other attribute in the new test, wherein the at least one value is not selected from the existing test.

15. The apparatus of claim 14, wherein the at least one value for the at least one other attribute is selected from a second existing test.

16. The apparatus of claim 14, wherein the at least one value for the at least one other attribute is generated.

17. The apparatus of claim 14, further comprising a coverage determination component for determining whether a coverage goal has been achieved by the new test.

18. A computer program product comprising:
a non-transitory computer readable medium;
a first program instruction for receiving an attribute collection related to a domain, the attribute collection comprising at least two attributes;
a second program instruction for receiving at least one restriction, the at least one restriction indicating at least one attribute, wherein a value for the at least one attribute is to be selected from one existing test;
a third program instruction for receiving an existing test; and
a fourth program instruction for generating at least one new test by setting values for the at least two attributes, wherein values for the at least one attribute of the at least one restriction are selected from the existing test, and at least one value for at least one other attribute are not selected from the existing test,
wherein said first, second third and fourth program instructions are stored on said non-transitory computer readable medium.
